(19) United States
(12) Patent Application Publication
(10) Pub. No.: US 2006/0233218 A1
(43) Pub. Date: Oct. 19, 2006

(54) Rapidly-sensed nipple-form clinical thermometer

(76) Inventor: Yung-Ku Lee, Taipei (TW)

Correspondence Address: Yung-Ku Lee, 235 Chung-Ho, Box 8-24, Taipei, TW

(21) Appl. No.: 11/107,700

(22) Filed: Apr. 18, 2005

(51) Int. Cl. G01K 13/00

(52) U.S. Cl. 374/151

(57) ABSTRACT

A rapidly-sensed nipple-form clinical thermometer comprises a mask having a nipple at a front end thereof; an interior of the nipple being formed with a straight groove located at a lower bottom of the nipple; a sensor placed at one side of the groove; a metal sensor wire extended from the sensor; a control unit with electronic operation functions connected to the sensor wire for calculating a temperature from the sensor; and a display screen at a rear end of the mask for receiving temperature values transferred from the control unit and displaying the temperature value. The sensor and the sensor wire are flatly adhered to a bottom of the groove. The sensor and sensor wire are fixed to a retainer in the groove. The retainer is made of insulated material and the nipple is made of silica gal.

### FIELD OF THE INVENTION

The present invention relates to clinical thermometers, and in particular to a rapidly-sensed nipple-form clinical thermometer, wherein a bottom of the silica gel nipple is formed with a groove; and a sensor and a sensor wire are placed in the groove so as to make the sensor and sensor wire are near to the tongue. Thus the temperature of the oral cavity can be sensed rapidly and effectively.

### BACKGROUND OF THE INVENTION

In currently use nipple-form clinical thermometer, the structures are complicated and the functions are not uniform. It is often that the users must take a long time for sensing the temperatures of the users. Furthermore, in the heat transferring process, since the heat is transferred through a long time, the heat will disperse so that the real body temperature cannot be measured accurately. If it is desired to have a preferred measuring result, the user must take longer time to have an accurate one.

Conventional, the nipple-form clinical thermometer is installed with a sensing unit which is generally made of silica gel. The silica gel is not a preferred heat conductivity. In measuring, the heat in oral cavity must take a long tome to transfer through a thick wall of the nipple to be transferred to the temperature sensor. Not only the time required is long, but also the accuracy is low.

For example, referring to FIG. 5, a current used nipple-form clinical thermometer is illustrated. An inner center of the nipple 31 is installed with a temperature sensor 33. A rear end of the temperature sensor is connected to a sensor wire 34. Another end of the sensor wire 34 is connected to a control unit 35 for adjusting the temperature value. Then the temperature value is transferred to a display screen 36 for displaying.

However, this prior art has the following disadvantages.

When the nipple-form clinical thermometer is placed in mouth. The tongue will contact a front end and bottom end of the silica gel nipple so that the temperature of the oral cavity will be transferred to the temperature sensor from the front surface of the silica gel nipple and then is transferred to the control unit from the sensor wire. Then the temperature value is processed by the control unit and then is displayed.

Since the silica gel is thick and is not preferred in heat conduction. Thereby it requires three minutes to transfer heat to the sensor.

Furthermore, the prior art sensor and sensor wire are embedded into the nipple. The tongue is only in contact with the foremost end of the sensor in the nipple and then the temperature is transferred to the control unit through the long sensor wire. Since the tongue has a long distance to the sensor wire at the center of the nipple and the sensor wire is long, the heat is dispersed in the transferring process. Thereby this make that five minutes are required in measuring the body temperature.

### SUMMARY OF THE INVENTION

Accordingly, the primary object of the present invention is to provide a rapidly-sensed nipple-form clinical thermometer, wherein a bottom of the silica gel nipple is formed with a groove; and a sensor and a sensor wire are placed in the groove so as to make the sensor and sensor wire are near to the tongue. Thus the temperature of the oral cavity can be sensed rapidly and effectively.

To achieve above objects, the present invention provides A rapidly-sensed nipple-form clinical thermometer comprises a mask having a nipple at a front end thereof; an interior of the nipple being formed with a straight groove located at a lower bottom of the nipple; a sensor placed at one side of the groove; a metal sensor wire extended from the sensor; a control unit with electronic operation functions connected to the sensor wire for calculating a temperature from the sensor; and a display screen at a rear end of the mask for receiving temperature values transferred from the control unit and displaying the temperature value. The sensor and the sensor wire are flatly adhered to a bottom of the groove. The sensor and sensor wire are fixed to a retainer in the groove. The retainer is made of insulated material and the nipple is made of silica gal.

The various objects and advantages of the present invention will be more readily understood from the following detailed description when read in conjunction with the appended drawing.

### BRIEF DESCRIPTION OF THE DRAWINGS

FIG. 1 is a schematic cross sectional view of the rapidly-sensed nipple-form clinical thermometer of the present invention.

FIG. 2 is a front view of the rapidly-sensed nipple-form clinical thermometer of the present invention.

FIG. 3 is a schematic view showing the use of the rapidly-sensed nipple-form clinical thermometer of the present invention.

FIG. 4 is a schematic view about the rapidly-sensed nipple-form clinical thermometer of the present invention.

FIG. 5 is a schematic view about the prior art nipple-form clinical thermometer.

### DETAILED DESCRIPTION OF THE INVENTION

In order that those skilled in the art can further understand the present invention, a description will be described in the following in detail. However, these descriptions and the appended drawings are only used to cause those skilled in the art to understand the objects, features, and characteristics of the present invention, but not to be used to confine the scope and spirit of the present invention defined in the appended claims.

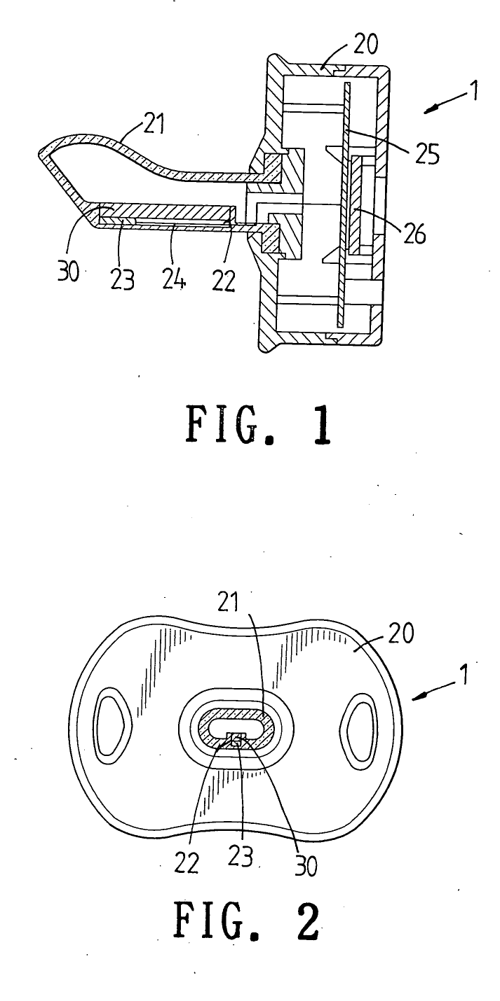

Referring to FIGS. 1 and 2, the present invention has the following elements.

A mask 20 has a nipple 21 at a front end thereof. The nipple 21 is made of silica gal. An interior of the nipple 21 is formed with a straight groove 22 located at a lower bottom of the nipple 21.

A sensor 23 is placed at one side of the groove 22. A metal sensor wire 24 with preferred heat conductivity is extended from the sensor 23. The sensor 23 and the sensor wire 24 are flatly adhered to a bottom of the groove 22. Upper sides of the sensor 23 and sensor wire 24 are fixed to an insulated retainer 30. One end of the sensor wire 24 extends to a rear end of the mask 20

A control unit 25 with electronic operation functions is connected to the sensor wire 24. The control unit 25 serves to calculate a temperature sensed at the sensor 23.

A display screen 26 at a rear end of the mask 20 serves to receive the temperature value transferred from the control unit 25 for displaying.

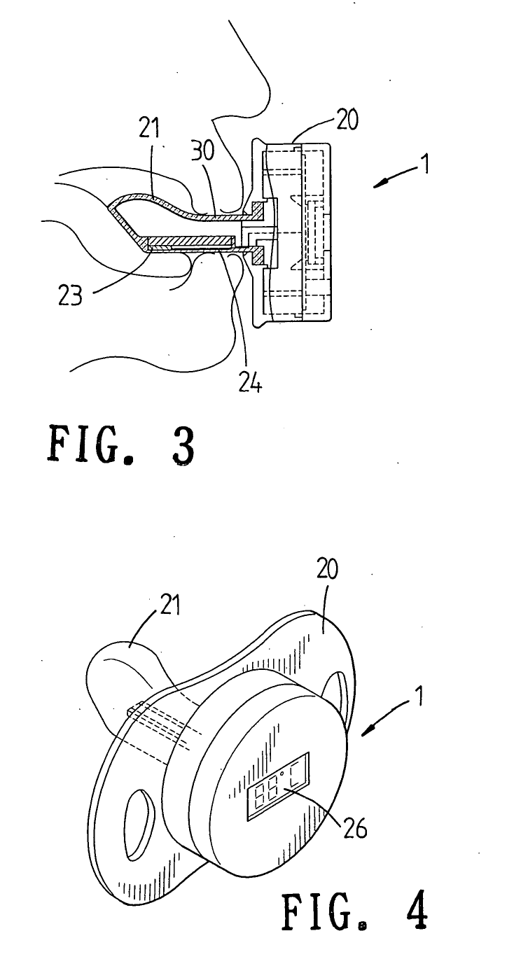

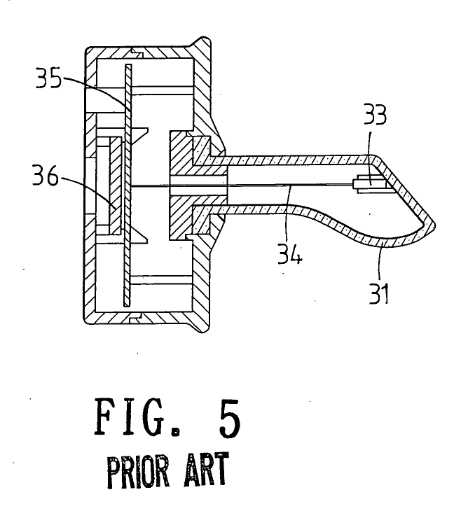

The use of the present invention is illustrated in FIGS. 3 and 4. When the nipple 21 is placed into an oral cavity to be bite therein. A front end and a lower end of the nipple 21 will be in contact with the tongue. Then the temperature of the tongue will be transferred to the control unit 25 through the sensor 23 and sensor wire 24 received in the groove 22 of the nipple 21. Then the temperature will be displayed by on the display screen 26.

Furthermore, in the present invention, the sensor 23 and sensor wire 24 are received in the front end and bottom end of the groove 22 of the nipple 21 so as to contact the front end and middle end of the tongue. Furthermore, by the special design of the groove 22 being at the bottom side of the nipple 21, the temperature of the tongue is sensed by the sensor 23 and sensor wire 24 simultaneously. No heat power is lost and the thermal equilibrium can be achieved quickly. Then by the electronic operation of the control unit 25, the temperature of the oral cavity is displayed on the sensor 23 quickly.

Then in the present invention, a bottom of the silica gel nipple 21 is formed with a groove 22; and the sensor 23 and sensor wire 24 are placed in the groove 22 so as to make the sensor 23 and sensor wire 24 are near to the tongue. Thus the temperature of the oral cavity can be sensed rapidly and effectively. Furthermore, the structure of the present invention is simple and thus the cost is low, even as it is compared with the prior art.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A rapidly-sensed nipple-form clinical thermometer comprising:
a mask having a nipple at a front end thereof; an interior of the nipple being formed with a straight groove located at a lower bottom of the nipple;
a sensor placed at a front side of the groove;
a metal sensor wire extended from the sensor;
a control unit with electronic operation functions connected to the sensor wire for calculating a temperature from the sensor; and
a display screen at a rear end of the mask for receiving temperature values transferred from the control unit and displaying the temperature value.

2. The rapidly-sensed nipple-form clinical thermometer as claimed in claim 1, wherein the sensor and the sensor wire are flatly adhered to a bottom of the groove.

3. The rapidly-sensed nipple-form clinical thermometer as claimed in claim 1, wherein the sensor and sensor wire are fixed to a retainer in the groove.

4. The rapidly-sensed nipple-form clinical thermometer as claimed in claim 3, wherein upper sides of the sensor and sensor wire are fixed to the retainer.

5. The rapidly-sensed nipple-form clinical thermometer as claimed in claim 3, wherein the retainer is made of insulated material.

6. The rapidly-sensed nipple-form clinical thermometer as claimed in claim 1, wherein the nipple is made of silica gal.
